(19) United States
(12) Patent Application Publication
(10) Pub. No.: US 2011/0050685 A1
(43) Pub. Date: Mar. 3, 2011

(54) IMAGE PROCESSING APPARATUS, IMAGE PROCESSING METHOD, AND PROGRAM

(76) Inventor: Hideshi YAMADA, Kanagawa (JP)

(21) Appl. No.: 12/859,110

(22) Filed: Aug. 18, 2010

(30) Foreign Application Priority Data
Aug. 26, 2009 (JP) P2009-195900

(51) Int. Cl. G06T 15/00

(52) U.S. Cl. 345/419

(57) ABSTRACT

An image processing apparatus, which creates a pseudo three-dimensional image that improves depth perception of the image, includes: an input image acquiring unit that acquires an input image and a binary mask image that specifies an object area on the input image; a combining unit that extracts pixels in an area inside a quadrangular frame picture of the input image and pixels in the object area, specified by the binary mask image, on the input image to create a combined image; and a frame picture combining position determining unit that determines a position on the combined image at which the quadrangular frame picture is placed so that one of a pair of opposite edges of the quadrangular frame picture includes an intersection with boundary of the object area and another of the pair does not include an intersection with the boundary of the object area.

### BACKGROUND OF THE INVENTION

1. Field of the Invention

The present invention relates to an image processing apparatus, an image processing method, and a program and, more particularly, to an image processing apparatus that can easily create a pseudo three-dimensional image by combing an object image obtained from an input image and a binary mask image, which specifies an object area on the input image, with a planar image that simulates a picture frame or architrave, to an image processing method, and to a program.

2. Description of the Related Art

In a method proposed to easily generate a three-dimensional image, a pseudo image is created by adding a depth image to a two-dimensional image rather than by supplying a three-dimensional image.

Japanese Unexamined Patent Application Publication No. 2008-084338, for example, proposes a method of creating a pseudo three-dimensional image by adding relief-like depth data to texture data, which is divided into objects.

A technique by which a pseudo three-dimensional image is created by combining an object cut from an image and a planar object together is also proposed (visit http://www.flickr.com/groups/oob/pool/).

An algorithm of software that aids pseudo three-dimensional image creation is also proposed, according to which a user deforms or moves an object to be combined by using a mouse or another pointer to edit a shadow of a photo object or computer graphics (CG) object (see 3D-aware Image Editing for Out of Bounds Photography, Amit Shesh et al., Graphics Interface, 2009).

### SUMMARY OF THE INVENTION

In the method proposed in Japanese Unexamined Patent Application Publication No. 2008-084338, however, the user gives the center of each divided object and sets a depth, making operations complex.

In the technique disposed at http://www.flickr.com/groups/oob/pool/, an image processing tool in a personal computer is used to process images, so the user who actually uses the image processing tool may not easily create pseudo three-dimensional images.

When creating a three-dimensional image as described in 3D-aware Image Editing for Out of Bounds Photography, Amit Shesh et al., Graphics Interface, 2009, the user uses a mouse to specify the position and shape of a frame; since this operation is complex, it is important for the user to have a skill to make an exact image.

It is desirable to easily create a pseudo three-dimensional image by combining an object image, which is obtained from an input image and a binary mask image that specifies an object area on the input image, with a planar image that simulates a picture frame or architrave.

An image processing apparatus according to an embodiment of the present invention creates a pseudo three-dimensional image that improves depth perception of the image; the image processing apparatus includes an input image acquiring means for acquiring an input image and a binary mask image that specifies an object area on the input image, a combining means for extracting pixels in an area inside a quadrangular frame picture of the input image and pixels in the object area, specified by the binary mask image, on the input image to create a combined image, and a frame picture combining position determining means for determining a position on the combined image at which the quadrangular frame picture is placed so that one of a pair of opposite edges of the quadrangular frame picture includes an intersection with a boundary of the object area and the other of the pair does not include an intersection with the boundary of the object area.

The quadrangular frame picture can be formed so that the edge that does not include the intersection with the boundary of the object area is longer than the edge that includes the intersection.

The position of the quadrangular frame picture can be determined by rotating the picture around a predetermined position.

The quadrangular frame picture can be formed by carrying out three-dimensional affine transformation on a predetermined quadrangular frame picture.

The combining means can create the combined image by continuously deforming the shape of the quadrangular frame picture and extracting the pixels in the area inside the quadrangular frame picture of the input image and the pixels in the object area, specified by the binary mask image, on the input image.

The combining means can create a plurality of combined images by extracting the pixels in the area inside the quadrangular frame picture, which has a plurality of types of shapes or is formed at a predetermined position, and the pixels in the object area, specified by the binary mask image, on the input image.

The combining means can create the combined image by storing input images or binary mask images, each of which is used to create the combined image, in correspondence to frame shape parameters, which include the rotational angle of the quadrangular frame picture, three-dimensional affine transformation parameters, and positions, by forming a frame picture with a predetermined quadrangular shape, according to the frame shape parameters stored in correspondence to a stored input image or binary mask image that is found, by comparison, to be most similar to the input image or binary mask image obtained by the input image acquiring means in the stored input images and binary mask images, and by extracting the pixels in the area inside the quadrangular frame picture of the input image and the pixels in the object area, specified by the binary mask image, on the input image.

An image processing method according to an embodiment of the present invention is a method for use in an image processing apparatus operable to create a pseudo three-dimensional image that improves depth perception of the image; the image processing method includes an input image acquiring step of acquiring an input image and a binary mask image that specifies an object area on the input image, a combining step of extracting pixels in an area inside a quadrangular frame picture of the input image and pixels in the object area, specified by the binary mask image, on the input image to create a combined image, and a frame picture combining position determining step of determining a position on the combined image at which the quadrangular frame picture is placed so that one of a pair of opposite edges of the quadrangular frame picture includes an intersection with a boundary of the object area and the other of the pair does not include an intersection with the boundary of the object area.

A program according to an embodiment of the present invention is executable by a computer that controls an image processing apparatus operable to create a pseudo three-dimensional image that improves depth perception of the image so as to execute a process including an input image acquiring step of acquiring an input image and a binary mask image that specifies an object area on the input image, a combining step of extracting pixels in an area inside a quadrangular frame picture of the input image and pixels in the object area, specified by the binary mask image, on the input image to create a combined image, and a frame picture combining position determining step of determining a position on the combined image at which the quadrangular frame picture is placed so that one of a pair of opposite edges of the quadrangular frame picture includes an intersection with a boundary of the object area and the other of the pair does not include an intersection with the boundary of the object area.

According to an embodiment of the present invention, an input image and a binary mask image that specifies an object area on the input image are acquired, pixels in an area inside a quadrangular frame picture of the input image and pixels in the object area, specified by the binary mask image, on the input image are extracted to create a combined image, and a position on the combined image at which the quadrangular frame picture is placed is determined so that one of a pair of opposite edges of the quadrangular frame picture includes an intersection with a boundary of the object area and the other of the pair does not include an intersection with the boundary of the object area.

According to the embodiments of the present invention, a pseudo three-dimensional image can be easily created by combining an object image, which is obtained from an input image and a binary mask image that specifies an object area on the input image, with a planar image that simulates a picture frame or architrave.

### BRIEF DESCRIPTION OF THE DRAWINGS

FIG. 1 is a block diagram showing an example of the structure of a pseudo three-dimensional image creating apparatus in an embodiment of the present invention;

FIG. 2 is a block diagram showing an example of the structure of the frame picture combining parameter calculator in FIG. 1;

FIG. 3 is a flowchart illustrating a pseudo three-dimensional image creation process;

FIG. 4 shows an input image and its binary mask image;

FIG. 5 illustrates a frame picture texture image;

FIG. 6 illustrates three-dimensional affine transformation parameters;

FIG. 7 illustrates three-dimensional affine transformation;

FIG. 8 is a flowchart illustrating a frame picture combining parameter calculation process;

FIG. 9 illustrates the frame picture combining parameter calculation process;

FIG. 10 also illustrates the frame picture combining parameter calculation process;

FIG. 11 shows an object layer images and a frame layer image;

FIG. 12 shows an exemplary combined image;

FIG. 13 illustrates a relation between a frame picture and an object image;

FIG. 14 shows another exemplary combined image;

FIG. 15 shows other exemplary combined images;

FIG. 16 shows other exemplary combined images; and

FIG. 17 is a block diagram showing the structure of an example of a general-purpose personal computer.

### DESCRIPTION OF THE PREFERRED EMBODIMENTS

### Example of the Structure of a Pseudo Three-Dimensional Image Creating Apparatus

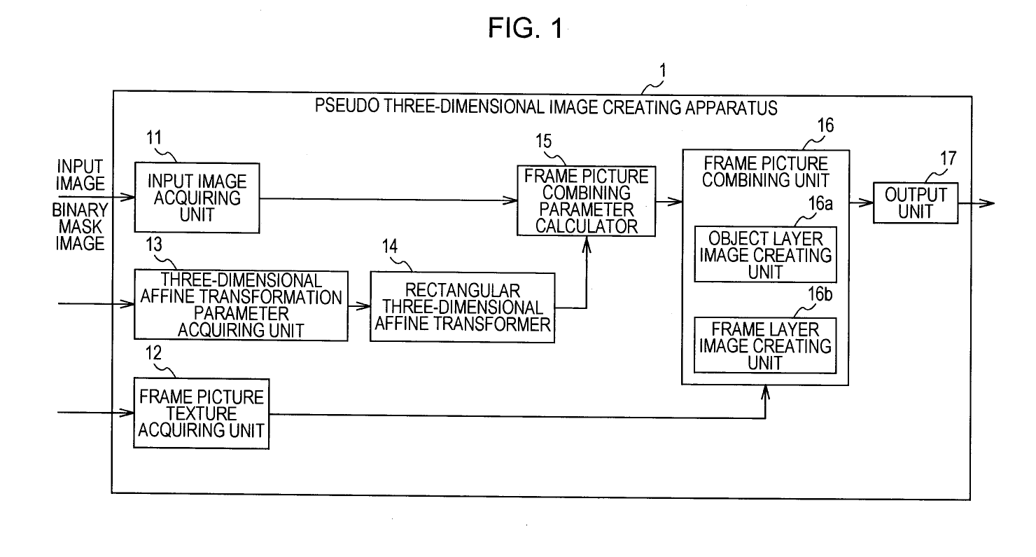

FIG. 1 is a block diagram showing an example of the structure of a pseudo three-dimensional image creating apparatus in an embodiment of the present invention. The pseudo three-dimensional image creating apparatus 1 in FIG. 1 combines an input image, a binary mask image, from which an object area on the input image has been cut off, and a frame picture texture image to create an image that spuriously appears to be a stereoscopic three-dimensional image.

More specifically, to spuriously create a pseudo stereoscopic image, the pseudo three-dimensional image creating apparatus 1 combines an image obtained by cutting off an object area from an input image according to its corresponding binary mask image with an image obtained by performing projection deformation of a frame picture texture image.

The pseudo three-dimensional image creating apparatus 1 has an input image acquiring unit 11, a frame picture texture acquiring unit 12, a three-dimensional affine transformation parameter acquiring unit 13, a rectangular three-dimensional affine transformer 14, a frame picture combining parameter calculator 15, a frame picture combining unit 16, and an output unit 17.

The input image acquiring unit 11 acquires an input image and a binary mask image that specifies an object area on the input image, and supplies the acquired images to the frame picture combining parameter calculator 15. The input image is an RGB color image in red, green, and blue, for example. The binary mask image has the same resolution as the input image and holds one of two values such as 1 and 0 to indicate whether the relevant pixel is included in the object area, for example. The input image and binary mask image are arbitrarily selected or supplied by the user. Of course, the input image and binary mask image are made to correspond to each other.

The frame picture texture acquiring unit 12 acquires a texture image to be attached to a quadrangle frame picture in, for example, a square shape, and supplies the texture image to the frame picture combining unit 16. The texture image visually appears as a plane; an example of it is an image that simulates a white frame of a printed photo.

The three-dimensional affine transformation parameter acquiring unit 13 acquires three-dimensional affine transformation parameters, which are used in three-dimensional affine transformation performed on the frame picture texture image, and supplies these parameters to the rectangular three-dimensional affine transformer 14. The three-dimensional affine transformation parameters may be directly specified with numerals or may be arbitrarily set according to user input operations through graphical user interfaces (GUIs) such as mouse drags and scroll bars.

The a rectangular three-dimensional affine transformer 14 calculates rectangular parameters from the three-dimensional affine transformation parameters acquired from the three-dimensional affine transformation parameter acquiring unit 13 and supplies the calculated rectangular parameters to the frame picture combining parameter calculator 15. The rectangular parameters indicate the two-dimensional coordinate of the four vertexes of the frame picture texture image after the three-dimensional affine transformation and the central position of the rectangle. The aspect ratio of the original rectangle used for the transformation may be specified by the user by operating an operation unit (not shown). Alternatively, the aspect ratio of the frame picture texture image entered by operating the operation unit may be used instead.

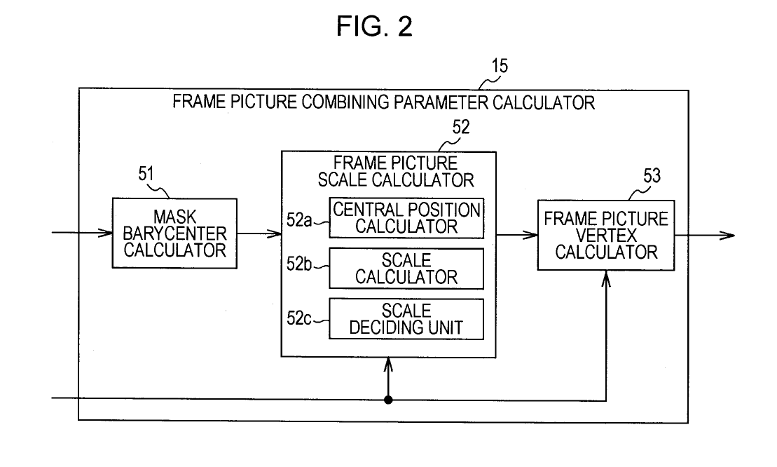

The frame picture combining parameter calculator 15 calculates the positions and scales of the input image and binary mask image, supplied from the input image acquiring unit 11, and the frame picture to be combined, and supplies frame picture parameters to the frame picture combining unit 16 together with the input image and binary mask image. The frame picture parameters supplied to the frame picture combining unit 16 indicate the four two-dimensional vertex coordinates of the quadrangular frame picture in the image coordinate system. The structure of the frame picture combining parameter calculator 15 will be described later in detail with reference to FIG. 2.

The frame picture combining unit 16 combines the input image, the binary mask image, and a frame shape structure image together according to the frame picture combining parameters to create a pseudo three-dimensional image on which its object visually appears to be stereoscopic, and then output the created image to the output unit 17. Specifically, the frame picture combining unit 16 includes an object layer image creating unit 16a and a frame layer image creating unit 16b. The object layer image creating unit 16a creates an image in the object area, that is, an object layer image from the input image, binary mask image, and frame shape structure image, according to the frame picture combining parameters. The frame layer image creating unit 16b creates an image in the frame picture texture area, that is, a frame layer image from the input image, binary mask image, and frame shape structure image, according to the frame picture combining parameters. The frame picture combining unit 16 combines the object layer image and frame layer image, which have been thus created, together to create a combined image, which is a pseudo three-dimensional.

The output unit 17 receives a combined image created as a pseudo three-dimensional image by the frame picture combining unit 16, and outputs the received image. Frame picture combining parameter calculator

Next, the structure of the frame picture combining parameter calculator 15 will be described in detail with reference to FIG. 2.

The frame picture combining parameter calculator 15 has a mask barycenter calculator 51, a frame picture scale calculator 52, and a frame picture vertex calculator 53. The frame picture combining parameter calculator 15 determines constraint conditions, which are used to obtain a frame picture shape, from the binary mask image to determine the position and scale of the frame picture.

To obtain the barycenter position of the object shape from the binary image, the mask barycenter calculator 51 obtains an average of the positions of the pixels in the object area, that is, all pixels in the binary mask image as the barycenter position. Then, the mask barycenter calculator sends the average to the frame picture scale calculator 52.

The frame picture scale calculator 52 has a central position calculator 52a, a scale calculator 52b, and a scale deciding unit 52c. The frame picture scale calculator 52 calculates a frame picture central position P_FRAME and a scale S_FRAME from the barycenter position and a frame setting angle θg, which is an input parameter, and sends the calculated values to the frame picture vertex calculator 53. The frame picture central position P_FRAME and scale S_FRAME will be described later in detail.

The frame picture vertex calculator 53 receives the frame picture central position P_FRAME and scale S_FRAME from the frame picture scale calculator 52, and outputs the four vertexes, which are frame picture combining parameters.

### Pseudo Three-Dimensional Image Creation Process

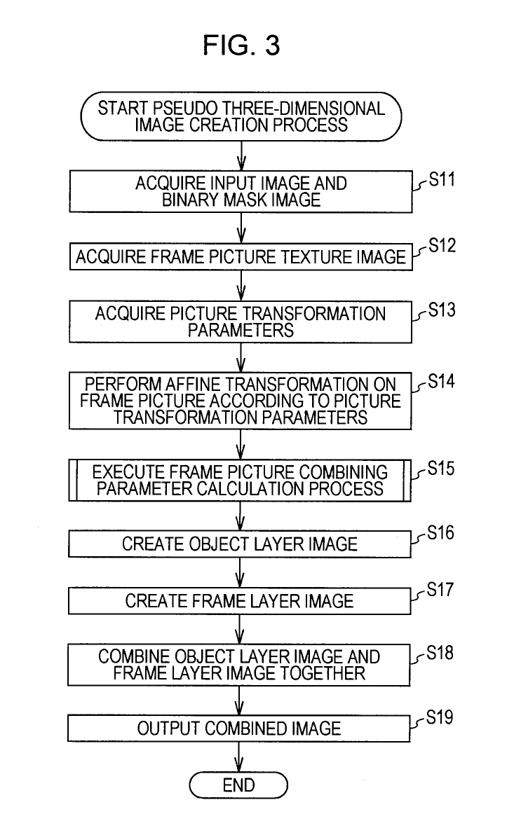

A pseudo three-dimensional image creation process will be described next with reference to the flowchart in FIG. 3.

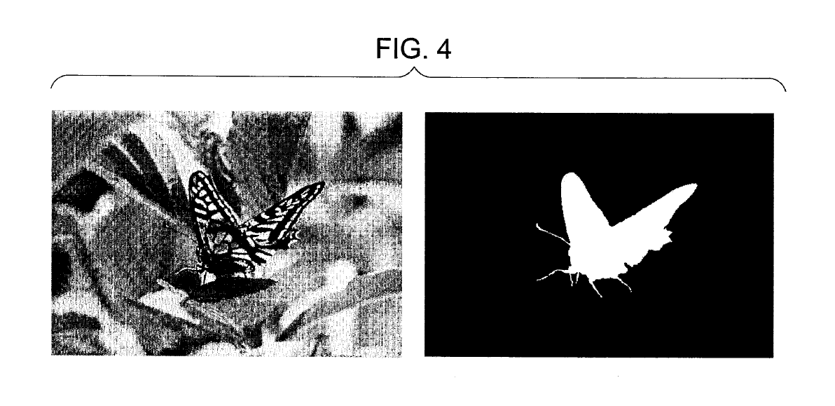

In step S11, the input image acquiring unit 11 acquires an input image and a binary mask image corresponding to the input image and then sends them to the frame picture combining parameter calculator 15. An exemplary input image and its corresponding binary mask image are respectively shown on the left and right in FIG. 4. In FIG. 4, the butterfly on the input image is an object image, so, on the binary mask image, pixels in the area in which the butterfly is displayed are displayed in white and pixels in the remaining area are displayed in black.

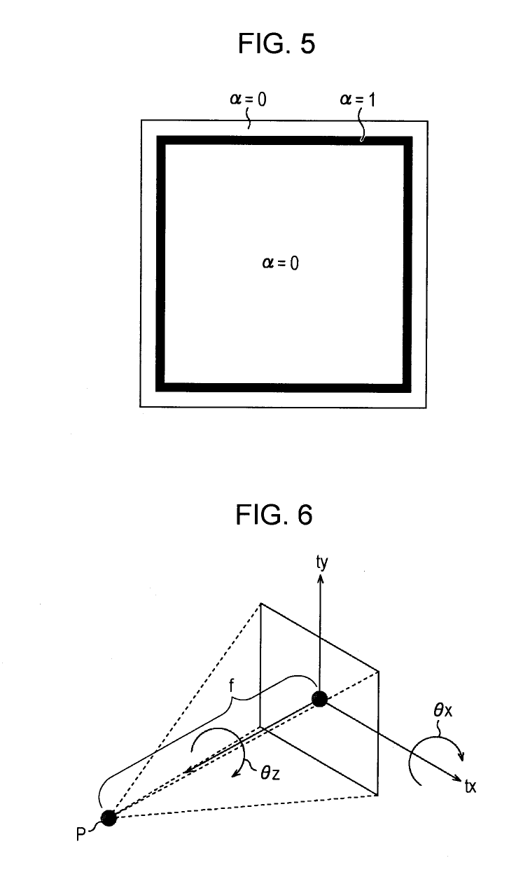

In step S12, the frame picture texture acquiring unit 12 acquires a frame picture texture image, which is selected when an operation unit (not shown) including a mouse and keyboard is operated, and sends the acquired image to the frame picture combining unit 16. An exemplary frame picture text image is shown in FIG. 5; the image is formed by pixels, the value of which is α. The outermost edge forming a frame is set to black, the pixel value a being 0; the inner edge next to the frame is set to white, the pixel value α being 1; the central part is set to black, the pixel value α being 0. That is, the frame picture texture image in FIG. 5 is formed from black and white edges.

In step S13, the three-dimensional affine transformation parameter acquiring unit 13 acquires three-dimensional affine transformation parameters, which are used to carry out three-dimensional affine transformation on the frame picture texture image, when the operation unit (not shown) is operated, and sends the acquired parameters to the rectangular three-dimensional affine transformer 14.

The three-dimensional affine transformation parameters are used to carry out affine transformation on a quadrangular frame picture so that the picture visually appears like a stereoscopic shape. Specifically, as shown in FIG. 6, these parameters are a rotation θx around the x axis, which is in the horizontal direction, a rotation θz around the z axis, which is line of sight, a distance f from an imaging position P to the frame used as the frame picture texture, which is a subject, a distance tx traveled in the x direction, which is horizontal to the image, and a distance ty traveled in the y direction, which is perpendicular to the image.

In step S14, the rectangular three-dimensional affine transformer 14 receives the three-dimensional affine transformation parameters sent from the three-dimensional affine transformation parameter acquiring unit 13, calculates rectangular parameters, and sends the calculated parameters to the frame picture combining parameter calculator 15.

Specifically, the rectangular three-dimensional affine transformer 14 obtains transformed coordinates by using a coordinate system, in which the central point of a rectangular frame picture is fixed to the origin (0, 0), the coordinate system being normalized to match the width in the x or y direction, whichever is longer. That is, when the rectangular frame picture is square, the rectangular three-dimensional affine transformer 14 sets the rectangular center RC and the four vertex coordinates p0 (−1, −1), p1 (1, −1), p2 (1, 1), p3 (−1, 1), which are taken before transformation. The rectangular three-dimensional affine transformer 14 then assigns the vertex coordinates p0 to p3, rectangular center RC, and three-dimensional affine transformation parameters to equation (1) to calculate vertex coordinates p0′ to p3′ and rectangular center RC′ transformed by three-dimensional affine transformation.

p′=T_{f}TₛR_{θx}R_{θz}p (1)

where R_{θz} is a rotational transformation matrix, represented by equation (2), that corresponds to a rotation θz about the z axis, and R_{θx} is a rotational transformation matrix, represented by equation (3), that corresponds to a rotation θx about the x axis; Tₛ is a transformation matrix, represented by equation (4), that corresponds to the distances tx and ty, and T_{f} is a transformation matrix, represented by equation (5), that corresponds to the distances f.

$$\begin{matrix}{R}_{{θ}_{z}} = [ \begin{matrix}cos {θ}_{z} & - sin {θ}_{z} & 0 & 0 \\ sin {θ}_{z} & cos {θ}_{z} & 0 & 0 \\ 0 & 0 & 1 & 0 \\ 0 & 0 & 0 & 1\end{matrix} ] & ( 2 ) \\ {R}_{{θ}_{x}} = [ \begin{matrix}1 & 0 & 0 & 0 \\ 0 & cos {θ}_{x} & sin {θ}_{x} & 0 \\ 0 & - sin {θ}_{x} & cos {θ}_{x} & 0 \\ 0 & 0 & 0 & 1\end{matrix} ] & ( 3 ) \\ {T}_{s} = [ \begin{matrix}1 & 0 & 0 & tx \\ 0 & 1 & 0 & ty \\ 0 & 0 & 1 & 0 \\ 0 & 0 & 0 & 1\end{matrix} ] & ( 4 ) \\ {T}_{f} [ \begin{matrix}1 & 0 & 0 & 0 \\ 0 & 1 & 0 & 0 \\ 0 & 0 & 1 & far \\ 0 & 0 & 0 & 1\end{matrix} ] & ( 5 )\end{matrix}$$

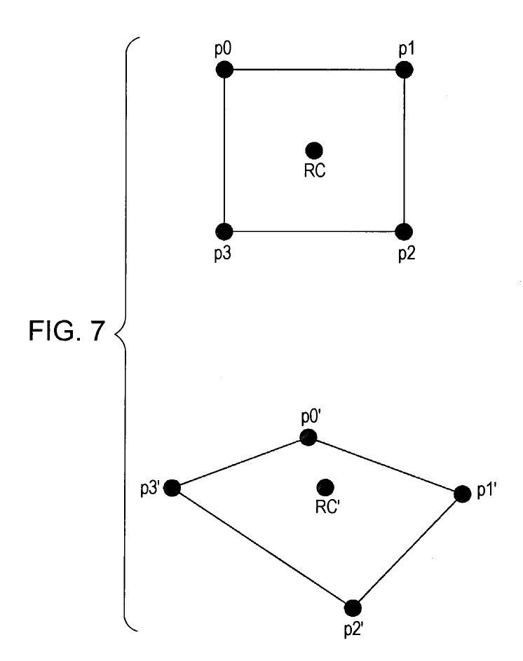

As a result of the transformation, a frame picture texture image such as an upper image in FIG. 7, represented by the vertex coordinates p0 to p3 of a rectangle and its center RC, is transformed into a frame picture texture image such as a lower image in FIG. 7, represented by the vertexes p0′ to p3′ of another rectangle and its center RC′. In this process, only the four vertex coordinates are obtained, and the frame picture texture image itself is not handled.

In step S15, the frame picture combining parameter calculator 15 executes a frame picture combining parameter calculation process to calculate frame picture combining parameters and sends the calculated parameters to the frame picture combining unit 16.

### Frame Picture Combining Parameter Calculation Process

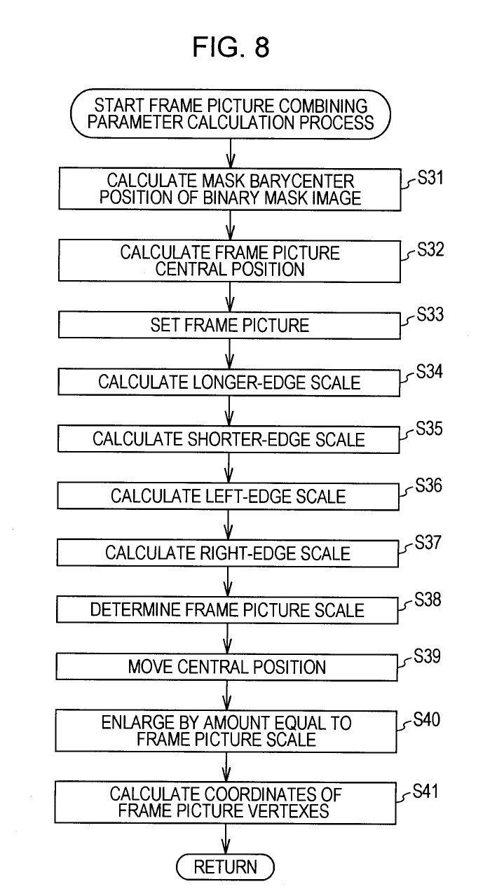

The frame picture combining parameter calculation process will be then described with reference to the flowchart in FIG. 8.

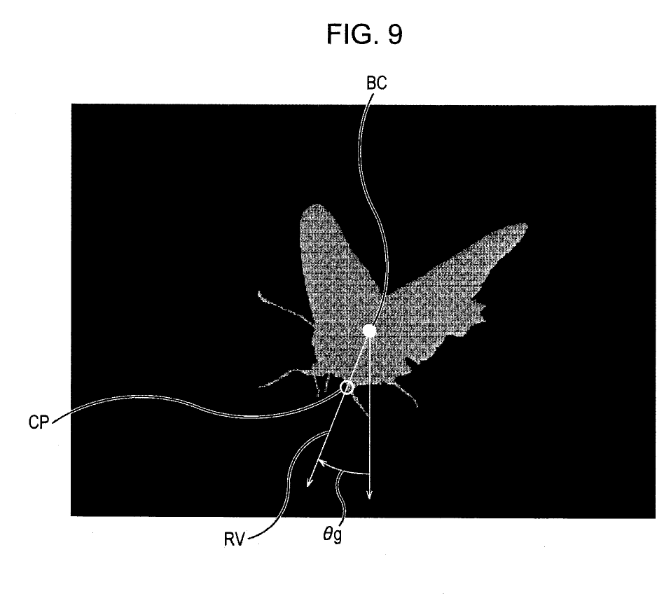

In step S31, the mask barycenter calculator 51 calculates the mask barycenter position BC of the shape of the object from the binary mask image, and sends the calculated barycenter position to the frame picture scale calculator 52. Specifically, as shown in FIG. 9, the mask barycenter calculator 51 extracts pixels with a pixel value α of 1 (pixels in white in the drawing) from all pixels in the binary mask image, which forms an object of a butterfly, and determines the average coordinates of these pixel positions as the mask barycenter position BC.

In step S32, the frame picture scale calculator 52 controls the central position calculator 52a to calculate the frame picture central position P_FRAME from the mask barycenter position BC received from the mask barycenter calculator 51 and from the frame setting angle θg, which is an input parameter.

Specifically, the central position calculator 52a first calculates a contour point CP to determine the position of the frame picture. That is, the central position calculator 52a obtains a vector RV, which has been rotated clockwise by the frame setting angle θg from the lower direction of the image, as shown in FIG. 9, the lower direction being handled as a reference vector. The central position calculator 52a further obtains, as the contour position CP, a two-dimensional position at which the pixel value a first changes from 1 to 0 during a motion from the mask barycenter position BC in the direction of the vector RV, that is, at which the contour of the object area (boundary of the object area) is first encountered, as shown in FIG. 9. The contour position CP is the central position P_FRAME of the frame picture texture.

In step S33, the scale calculator 52b sets the frame picture texture image to calculate the scale S_FRAME, which is the scale of the frame picture. Specifically, the scale calculator 52b rotates the frame picture texture image formed by the vertex coordinates p0′ to p3′ of the rectangle and its center RC′, which are obtained after three-dimensional affine transformation, by the frame setting angle θg, to update the vertex coordinates to p0″ to p3″. That is, the frame picture texture image is rotated clockwise, centered around the rectangular center RC′ and the vertex coordinates p0′ to p3′ are updated to the vertex coordinates p0″ to p3″.

Accordingly, if the frame setting angle θg is 0 degree, for example, the frame picture texture is disposed at the bottom of the object; if θg is 90 degrees, the frame picture texture is disposed so that it stands on the left side of the object.

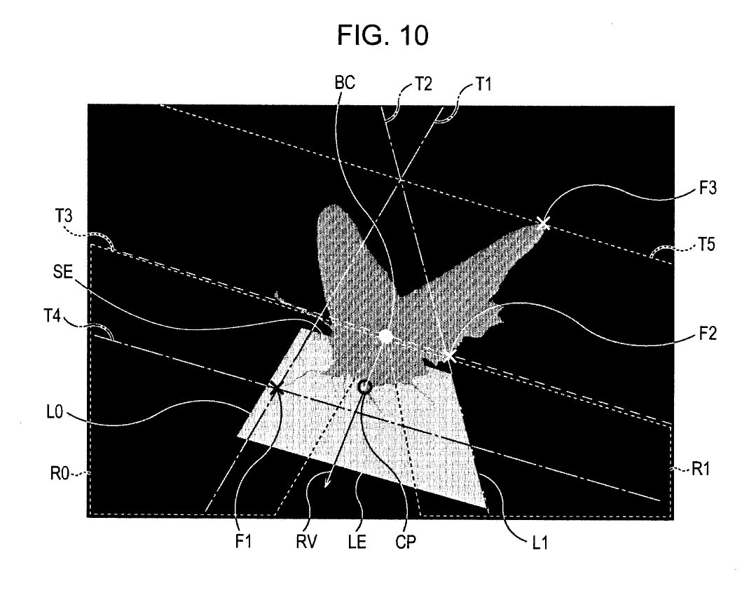

In step S34, the scale calculator 52b determines a longer edge LE and a shorter edge SE from the vertex coordinates p0″ to p3″ to obtain a straight line of each edge. For example, the longer edge LE is the longest edge of the frame picture texture and the shorter edge SE is the edge opposite to the longer edge LE, as shown in FIG. 10. When the frame picture texture is traced clockwise, the edge placed next to the longer edge LE is the left edge LO and the edge placed next to the shorter edge SE is the right edge L1.

The scale calculator 52b calculates, as a longer-edge scale S_LE, a scale when the longer edge LE passes through the farthest point in the direction of the vector RV of the binary mask image. Specifically, in the case shown in FIG. 10, the scale calculator 52b calculates, as the longer-edge scale S_LE, the scale when the longer edge LE passes through the intersection F1 (on the straight line T4), which is the farthest point intersecting with the object image in the direction of the vector RV from the straight line T3, which passes through the mask barycenter position BC and is orthogonal to the vector RV. That is, when the frame picture is enlarged or reduced about the central position P_FRAME (contour point CP), the longer scale S_LE is obtained as an enlargement ratio or reduction ratio when the longer edge LE is disposed on the straight line T4.

In step S35, the scale calculator 52b calculates, as a shorter-edge scale S_SE, a scale when the shorter edge SE passes through the farthest point in the direction opposite to the direction of the vector RV of the binary mask image. Specifically, in the case shown in FIG. 10, the scale calculator 52b calculates, as the shorter-edge scale S_SE, the scale when the shorter edge SE passes through the intersection F3 (on the straight line T5), which is the farthest point intersecting with the object image in the direction opposite to the direction of the vector RV from the straight line T3, which passes through the mask barycenter position BC and is orthogonal to the vector RV. That is, when the frame picture is enlarged or reduced about the central position P FRAME (contour point CP), the shorter scale S_SE is obtained as an enlargement ratio or reduction ratio when the shorter edge SE is disposed on the straight line T5.

In step S36, as shown in FIG. 10, the scale calculator 52b calculates, as a left-edge scale S_L0, a scale when the left edge L0 is in the direction of the vector RV relative to the straight line T3, which passes through the mask barycenter position BC and is perpendicular to the vector RV, and includes the intersection F1 (on the straight line T1) with the object image in the area R0 on the left edge L0 side relative to the straight line R0R that passes through the mask barycenter position BC and is parallel to the left edge L0 and when the left edge L0 passes through the intersection F1 with the object image, which is at the farthest point from the straight line R0R that passes through the mask barycenter position BC and is parallel to the left edge L0. That is, when the frame picture is enlarged or reduced about the central position P_FRAME (contour point CP), the left-edge scale S_L0 is obtained as the enlargement ratio or reduction ratio applied when the left-edge L0 is positioned on the straight line T1.

In step S37, the scale calculator 52b calculates, as a right-edge scale S_L1, a scale when the right edge L1 is in the direction of the vector RV relative to the straight line T3, which passes through the mask barycenter position BC and is perpendicular to the vector RV, and includes the intersection F2 (on the straight line T2) with the object image in the area R1 on the right edge L1 side relative to the straight line R1L that passes through the mask barycenter position BC and is parallel to the right edge L1 and when the right edge L1 passes through the intersection F2 with the object image, which is at the farthest point from the straight line R1L that passes through the mask barycenter position BC and is parallel to the right edge L1. That is, when the frame picture is enlarged or reduced about the central position P_FRAME (contour point CP), the right-edge scale S_L1 is obtained as the enlargement ratio or reduction ratio applied when the right edge L1 is positioned on the straight line T2.

In step S38, the scale deciding unit 52c calculates the scale S_FRAME of the frame picture texture by using the longer-edge scale S_LE, shorter-edge scale S_SE, left-edge scale S_L0, and right-edge scale S_L1, according to equation (6) below.

S_FRAME=MIN(β×MAX(S_LE, S_{—}L0, S_{—}L1), S_SE) (6)

where β, which takes a value of 1 or more, is an arbitrary coefficient to adjust the size of the frame picture, MAX(A, B, C) is a function to select the maximum value of values A to C, MIN(D, E) is a function to select the minimum value of values D and E. Accordingly, the scale deciding unit 52c obtains the maximum value of the longer-edge scale S_LE, left-edge scale S_L0, and right-edge scale S_L1 and also obtains the minimum value of the obtained maximum value and shorter-edge scale S_SE, as the scale S_FRAME of the frame picture texture. The frame picture scale calculator 52 then sends the calculated scale S_FRAME and central position P_FRAME to the frame picture vertex calculator 53.

Comparison with the shorter-edge scale S_SE is carried out only with MIN(D, E) in equation (6). This is because, the shorter-edge scale S_SE, the distance from the central position P_FRAME (contour point CP) to the farthest point of the object is longer when compared to the other farthest points, as shown in FIG. 10, that is, the shorter-edge scale S_SE is extremely larger than the other scales.

In step S39, the frame picture vertex calculator 53 uses the central position P_FRAME and scale S_FRAME of the frame picture texture, which have been received from the frame picture scale calculator 52, to perform parallel movement so that the central position RC″ of the frame picture texture matches the central position P_FRAME, which is the barycenter position BC.

In step S40, the frame picture vertex calculator 53 enlarges each edge about the central position of the frame picture texture by an amount equal to the scale S_FRAME.

In step S41, the frame picture vertex calculator 53 obtains the two-dimensional positions FP0 to FP3 of the four vertexes of the enlarged frame picture texture, and then sends the obtained two-dimensional positions FP0 to FP3 of the four vertexes to the frame picture combining unit 16 at a later stage as the frame picture combining parameters.

According to the processes described above, the frame picture combining parameters can be set so that the two-dimensional coordinates of the four vertexes of the frame picture texture become optimum for the object area on the basis of the longer edge, shorter edge, left edge, and right edge of the frame picture texture and the farthest distance in the object area.

Now, the process in the flowchart in FIG. 3 will be described again.

In step S15, the frame picture combining parameter calculation process is executed to calculate frame picture combining parameters, after which the sequence proceeds to step S16.

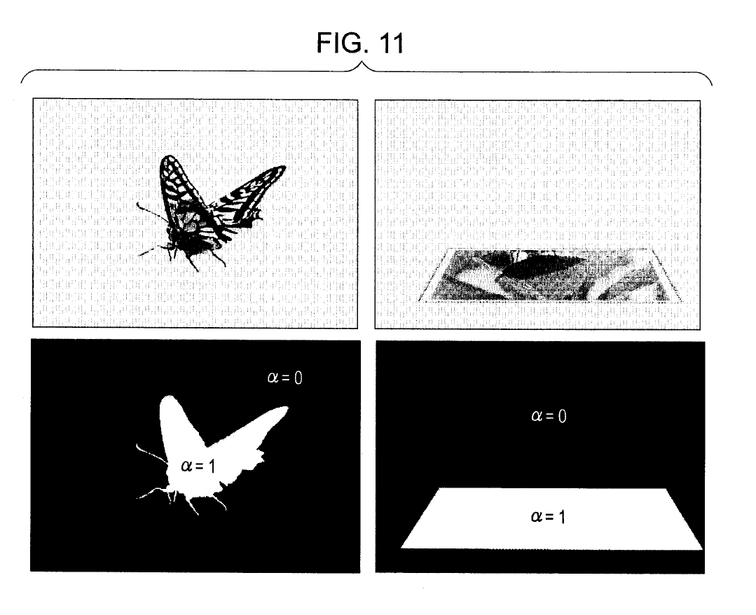

In step S16, the frame picture combining unit 16 controls the object layer image creating unit 16a to create an object layer image from an input image and binary mask image. Specifically, for example, the object layer image creating unit 16a creates, in the object area, an object layer image as shown in the upper left part of FIG. 11 from a binary mask image as shown in the lower left part of FIG. 11, the mask image being made up of pixels with the pixel value α being set to 1 and pixels with the pixel value α being set to 0 (indicating black).

In step S17, the frame picture combining unit 16 controls the frame layer image creating unit 16b to create a frame layer image rendered by mapping the frame picture texture image to the frame picture texture, which has undergone projection deformation by the frame picture combination parameters. Specifically, for example, the frame layer image creating unit 16b creates a binary mask image of a quadrangular frame picture, as shown in the lower-right part of FIG. 11, according to two-dimensional vertex coordinates given as the frame picture parameters. In an area in which the frame picture is drawn on the binary mask image of the frame picture, α is 1, where the pixel values of the input image are output; in the other area, α is 0, where all pixel values are 0. Then, the frame layer image creating unit 16b creates the frame layer image, as shown in the upper right part of FIG. 11, from the input image and the created binary mask image of the frame picture.

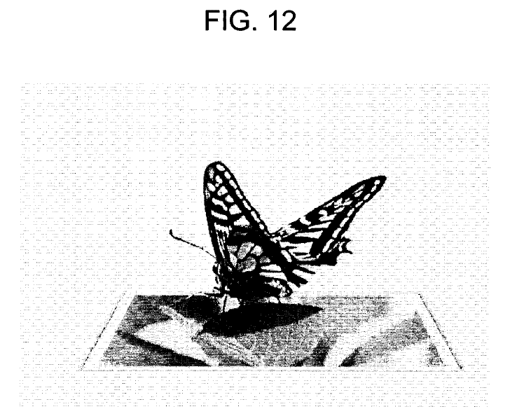

In step S18, the frame picture combining unit 16 combines the object layer image and frame layer image together to create a combined pseudo three-dimensional image as shown in FIG. 12, and sends the combined image to the output unit 17.

In step S19, the output unit 17 outputs the combined pseudo three-dimensional combined image, which has been created.

The processes described above can thus create a pseudo three-dimensional image that uses, as depth perception of a person, an overlap of a frame picture texture image and a perspective of a rectangular object for which projection transformation has been performed.

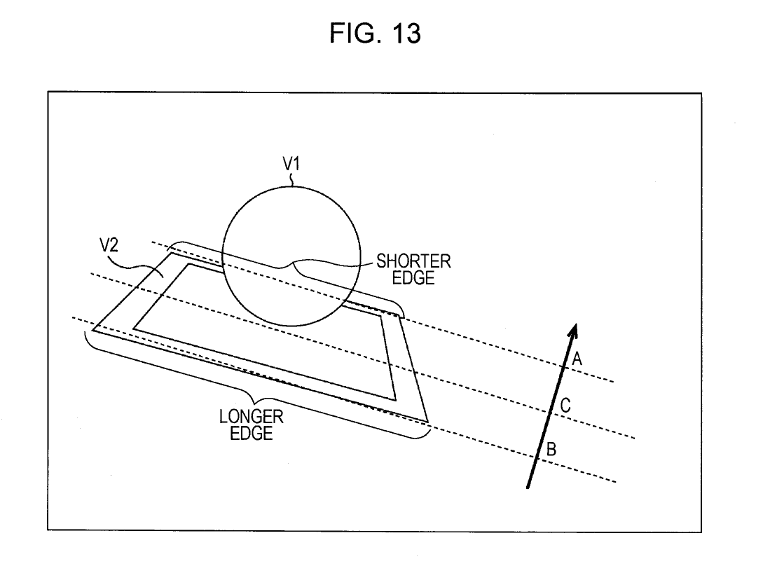

That is, as for the eyesight of a person, depth perception can be generally attained by obtaining a clue such as perspective projection and vanishing points from a rectangle for which projection transformation has been performed. A fore-and-aft relation can also be obtained from an order in which an object image and frame image overlap, as the eyesight. To have a person recognize the fore-and-aft relation represented by a perspective and overlap through the eyesight in this way, it may suffice to satisfy conditions as shown in FIG. 13.

Specifically, a first condition is that the edge on the far side of a frame picture, that is, the shorter edge overlaps an object and is behind the object. More specifically, the first condition is that, for example, as shown in FIG. 13, the shorter edge of a frame picture V2 has intersections with the boundary of an object area V1 and only the object is displayed in the object area V1.

A second condition is that the edge on the near side of the frame picture, that is, the longer edge has no intersection with the boundary of the object area. Specifically, the second condition is that, for example, as shown in FIG. 13, the longer edge of the frame picture V2 has no intersection with the boundary of the object area V1.

A third condition is that the frame picture has a shape that can be three-dimensionally present. Specifically, the third condition is that the frame picture V2 has a shape that can be three-dimensionally present.

The first and second conditions are satisfied by disposing the longer edge B of the frame picture V2, a straight line C passing through a bottom point of the object area, and the shorter edge A of the frame picture V2 in that order from the near side, as shown in FIG. 13. That is, it suffices that the shorter side of the frame picture V2 has intersections with the boundary of the object area, the object is displayed between the intersections, and the shorter edge of the frame picture V2 has no intersection with the boundary of the object area.

In the frame picture combining parameter calculation process in FIG. 8, any one of the scales, which have been enlarged or reduced about the central position P_FRAME so that the longer edge, shorter edge, right edge, or left edge passes its farthest point of the object area, is set as the scale S_FRAME. Accordingly, the scale of the frame picture is determined so that the longer edge has no intersection with the object area and the shorter edge has intersections with the object area.

As a result, since the object image is combined with the frame picture enlarged or reduced as described above, a pseudo three-dimensional image that visually appears to be stereoscopic can be created.

According to the embodiments of the present invention, a pseudo three-dimensional image can be easily created by combining an object image, which is obtained from an input image and a binary mask image that specifies an object area on the input image, with a planar image that simulates a picture frame or architrave.

When the frame picture is deformed only by three-dimensional affine transformation, the frame picture can remain in a three-dimensional shape. When a texture is mapped to the frame picture itself by, for example, projection transformation, information usable as a clue of a perspective can be given, improving depth perception.

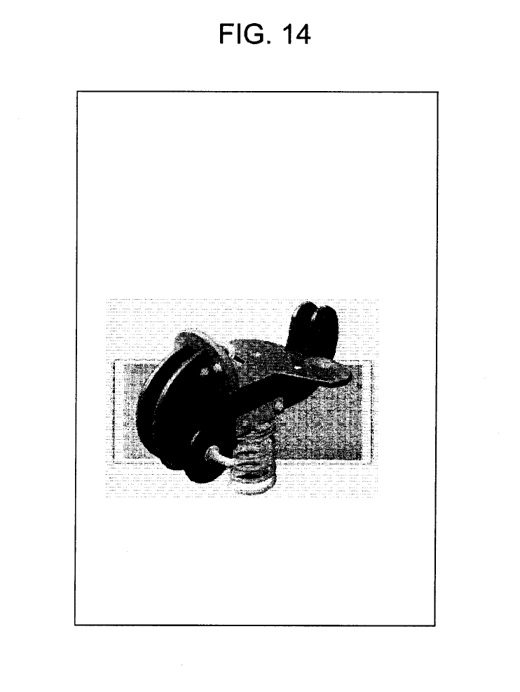

As shown in FIG. 14, for example, when two opposite edges of a quadrangular frame picture intersect the object area of an airplane-shaped toy, a pseudo three-dimensional image that a user can enjoy can also be created. In this case, to determine the shape of the frame picture, the barycenter of the object area is obtained, for example, after which, centered around the barycenter, the widths can be calculated as twice the maximum value and minimum value in the X direction of the object area, and the heights can be calculated as half the maximum value and minimum value in the Y direction. A depth emphasizing effect can be obtained just by placing the frame picture behind the object.

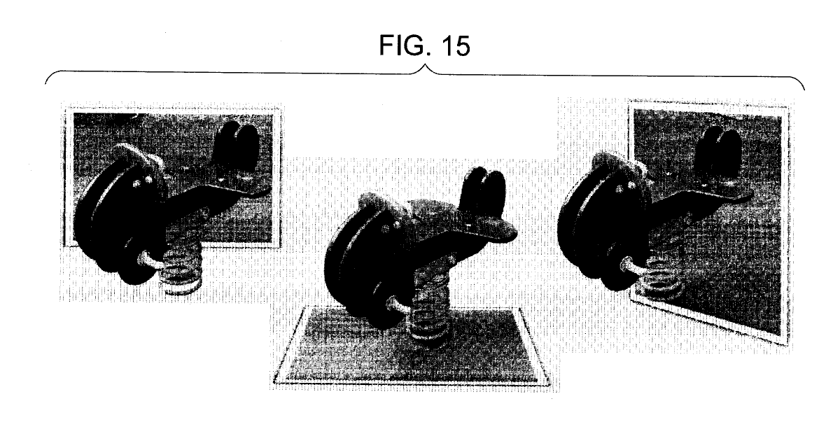

The frame picture combining parameter calculator 15 can also place the frame picture upside down or oppositely, rather than on the ground, by adjusting the frame setting angle θg. Specifically, as shown in FIG. 15, the frame picture can be placed behind the airplane-shaped toy, which is the object, or inverted parallel to the toy.

The frame picture combining parameter calculator 15 may also calculate the N-order moment of the binary mask image and the center of a bounding box or the center of a circumscribed circle as the parameters to calculate the frame picture shape. That is, mask image distribution may be considered for the central position instead of using a simple barycenter position.

The frame picture combining parameter calculator 15 may obtain the parameters to calculate the frame picture shape not only from the binary mask image but also from the input image itself. Specifically, the vanishing points of the image or the ground may be detected to determine the shape and position of the frame picture so that an edge of the frame picture is placed along a varnishing line of the input image or in a ground area. For a method of automatically detecting a varnishing line from an image, see “A new Approach for Vanishing Point Detection in Architectural Environments, Carsten Rother, BMVC2000”.

In this method, edges of an architectural structure are detected and the direction of parallel edges is statistically processed to calculate varnishing points. Two varnishing points obtained by this method can be used to calculate the frame picture combining parameters. Specifically, the constraint that opposite edges of the frame picture converge at two different varnishing points is added in determination of the position and shape of the frame picture.

A projection transformation parameter f of the frame picture may also be determined by obtaining an approximate object size from object classification based on machine learning.

Specifically, a pseudo three-dimensional image that is more naturally stereoscopic may be created by using camera parameters for macro photography when the object is small like a cup or by using camera parameters for telescopic photography when the object is large like a building. For the method of classifying objects, see “Object Detection by Joint Feature Based on Relations of Local Features, Fujiyoshi Hironobu”. In this method, machine learning is carried out in advance for features based on relation of local features of an object and the image if found from an image.

The frame picture combining parameter calculator 15 may also render an object picture to which a texture image is not mapped, during frame layer image creation. In this case, a rectangle may be drawn just by specifying a color for the frame picture or the pixel colors of the input image may be drawn.

A user interface may be provided so that the user can correct the shape of the frame picture while viewing the pseudo three-dimensional image calculated by the frame picture combining unit 16. Specifically, the user may operate the user interface to move the four vertexes of the frame picture or move the entire frame picture. Alternatively, an interface to change the burnishing point to deform the frame picture may be provided.

A user input may be supplied to the three-dimensional affine transformation parameter acquiring unit 13 to directly update the frame shape parameters.

The frame picture combining unit 16 may deform the binary mask image itself. Specifically, when a frame picture object is combined at the bottom of an object area, specified by the binary mask image, that continuously extends to the bottom of the image, the binary mask image may be cut so that the binary mask image does not extend beyond the frame picture toward the near side, creating a pseudo three-dimensional image that is naturally stereoscopic.

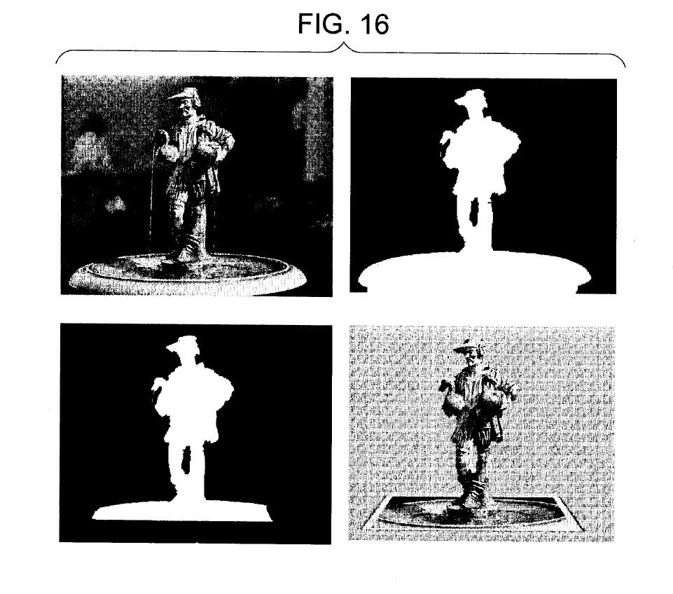

Specifically, when a binary mask image as shown in the upper-right part of FIG. 16 is input for an input image as shown in the upper-left part of FIG. 16, part of the fountain base on which a doll, which is an object, is mounted is cut to match the frame picture as shown in the lower-left part of FIG. 16. When the input image is processed by using the resulting binary mask image shown in the lower-left part of FIG. 16, a pseudo three-dimensional image, as shown in the lower-right part of FIG. 16, in which the fountain base is cut to match the frame picture shape can be created.

The input image is not limited to a still image; it may be a moving image. When the input image is a moving image, the frame picture parameters may be determined from a representative moving image frame and a mask image to determine the shape of the frame picture. To determine the shape of the frame picture, the frame picture parameters may also be determined for each moving image frame.

The frame picture may not be a still image; an image created by changing the three-dimensional affine transformation parameters or frame setting angle parameters may be animated.

Not only a processing result is presented by a combination of one type of parameter, but also a plurality of processing results may be output by a combination of a plurality of parameters. That is, the pseudo three-dimensional image creating apparatus may present pseudo three-dimensional images created by a combination of a plurality of parameters within a predetermined parameter range, and the user may select a preferable image from the presented images.

The frame picture combining unit 16 may use processed input images, such as blurred input images, gray-scaled images, or images with low brightness, instead of filling the areas other than the frame picture and object, that is, the background with a background color.

An alpha map or a try-map may be input as the binary mask image.

A plurality of three-dimensional transformation parameters may be prestored in a database, and appropriate parameters may be selected from the database and input as the three-dimensional transformation parameters acquired by the three-dimensional affine transformation parameter acquiring unit 13.

Specifically, the three-dimensional affine transformation parameter acquiring unit 13 creates, in advance, reference binary mask images and their three-dimensional affine transformation parameters by which the frame picture shape becomes optimum for the reference binary mask images, and stores the reference binary mask images three-dimensional affine transformation parameters in correspondence to each other. The three-dimensional affine transformation parameter acquiring unit 13 then selects, from the database, a reference binary mask image having a high similarity to the entered binary mask image, and acquires and outputs the three-dimensional affine transformation parameters stored in correspondence to the selected reference binary mask image.

Accordingly, the appropriate three-dimensional affine transformation parameters can be acquired from the database and can be used to deform or combine a frame picture object.

For a method of calculating a similarity to an image, see “Zhong Wu, Qifa Ke, Michael Isard, and Jian Sun. Bundling Features for Large Scale Partial-Duplicate Web Image Search. CVPR 2009 (oral)”. In this method, a feature called SIFT at a key point and an area feature called MSER are used to represent the feature of an image, and the similarity of the image is obtained by calculating the distances of these features in a feature space. That is, binary mask image features and reference binary mask image features, which are calculated in advance and stored in the database, may be obtained and compared to find an image with the largest similarity, and the three-dimensional affine transformation parameter stored in correspondence to the image may be used.

The similarity calculation may be carried out not only between binary mask images but also between images. That is, both the feature of the input image and the features of the binary mask image may be used together in the similarity calculation as a new feature.

The frame picture may be a three-dimensional object rather than a two-dimensional texture. In this case, the three-dimensional object is mapped to an XY plane, and a bounding rectangle of the mapped three-dimensional object is calculated as the input rectangle. The bounding rectangle is used as an ordinary two-dimensional rectangle to determine its position and scale in advance. After the three-dimensional object undergoes three-dimensional affine transformation as in the bounding rectangle, a position and scale are applied to the three-dimensional object, which is then combined with the object in the input image. In this way, the object image can be combined with a curved frame or thickened frame to create a three-dimensional image for which depth perception is enhanced.

Although a series of processes described above can be executed by hardware, it can also be executed by software. When the series of processes is executed by software, programs constituting the software are installed from a storage medium into, for example, a computer embedded in dedicated hardware or a general-purpose personal computer that can execute various functions after various programs are installed therein.

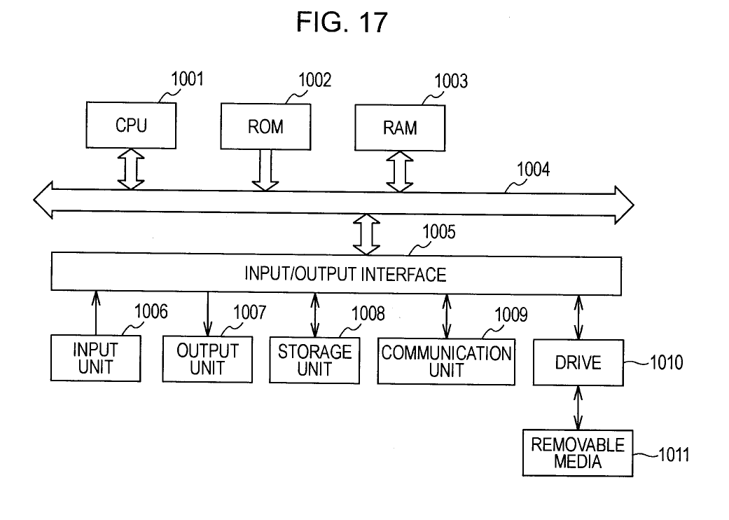

FIG. 17 shows an example of the structure of a general-purpose personal computer, in which a central processing unit (CPU) 1001 is included. An input/output interface 1005 is connected to the CPU 1001 via a bus 1004. A read-only memory (ROM) 1002 and a random-access memory (RAM) 1003 are connected to the bus 1004.

Units connected to the input/output interface 1005 are an input unit 1006, including a keyboard, a mouse, and other input devices, through which the user enters operation commands, an output unit 1007 that outputs processing operation screens and images obtained as a result of processing to a display device, a storage unit 1008 including a hard disk drive that stores programs and various types of data, and a communication unit 1009, including a local area network (LAN) adapter, which executes communication processing through a network typified by the Internet. Another unit connected to the input/output interface 1005 is a drive 1010 that writes and read data to and from a removable media 1011 such as a magnetic disc (including a flexible disc), an optical disc (including a compact disc read-only memory (CD-ROM), and a digital versatile disc (DVD)), a magneto-optical disc (including a mini-disc (MD)), or a semiconductor memory.

The CPU 1001 executes various processes according to the programs that have been stored in the ROM 1002 or that are read from the removable media 1011 such as a magnetic disk, optical disk, magneto-optical disk, or semiconductor memory, installed in the storage unit 1008, and loaded from the storage unit 1008 into the RAM 1003. Data used by the CPU 1001 to execute the various processes is also stored in the RAM 1003 at appropriate times.

For steps describing processes in this description, the processes described so that they are executed in time series in the order described may include processes that are not executed in time series but in parallel or individually.

The present application contains subject matter related to that disclosed in Japanese Priority Patent Application JP 2009-195900 filed in the Japan Patent Office on Aug. 26, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus creating a pseudo three-dimensional image that improves depth perception of the image, the apparatus comprising:
input image acquiring means for acquiring an input image and a binary mask image that specifies an object area on the input image;
combining means for extracting pixels in an area inside a quadrangular frame picture of the input image and pixels in the object area, specified by the binary mask image, on the input image to create a combined image; and
frame picture combining position determining means for determining a position on the combined image at which the quadrangular frame picture is placed so that one of a pair of opposite edges of the quadrangular frame picture includes an intersection with a boundary of the object area and another of the pair does not include an intersection with the boundary of the object area.

2. The image processing apparatus according to claim 1, wherein the quadrangular frame picture is formed so that the edge that does not include the intersection with the boundary of the object area is longer than the edge that includes the intersection.

3. The image processing apparatus according to claim 1, wherein a position of the quadrangular frame picture may be determined by rotating the quadrangular frame picture around a predetermined position.

4. The image processing apparatus according to claim 1, wherein the quadrangular frame picture is formed by carrying out three-dimensional affine transformation on a predetermined quadrangular frame picture.

5. The image processing apparatus according to claim 1, wherein the combining means creates the combined image by continuously deforming a shape of the quadrangular frame picture and extracting the pixels in the area inside the quadrangular frame picture of the input image and the pixels in the object area on the binary mask image of the input image.

6. The image processing apparatus according to claim 1, wherein the combining means creates a plurality of combined images by extracting the pixels in the area inside the quadrangular frame picture, which has a plurality of types of shapes or is formed at a predetermined position, and the pixels in the object area, specified by the binary mask image, on the input image.

7. The image processing apparatus according to claim 1, wherein the combining means creates the combined image:
by storing input images or binary mask images, each of which is used to create the combined image, in correspondence to frame shape parameters, which include a rotational angle of the quadrangular frame picture, three-dimensional affine transformation parameters, and positions;
by forming a frame picture with a predetermined quadrangular shape, according to the frame shape parameters stored in correspondence to a stored input image or binary mask image that is found, by comparison, to be most similar to the input image or binary mask image obtained by the input image acquiring means in the stored input images and binary mask images; and
by extracting the pixels in the area inside the quadrangular frame picture of the input image and the pixels in the object area, specified by the binary mask image, on the input image.

8. An image processing method for use in an image processing apparatus operable to create a pseudo three-dimensional image that improves depth perception of the image, the method comprising the steps of:
acquiring an input image and a binary mask image that specifies an object area on the input image;
extracting pixels in an area inside a quadrangular frame picture of the input image and pixels in the object area, specified by the binary mask image, on the input image to create a combined image; and
determining a position on the combined image at which the quadrangular frame picture is placed so that one of a pair of opposite edges of the quadrangular frame picture includes an intersection with a boundary of the object area and another of the pair does not include an intersection with the boundary of the object area.

9. A program executable by a computer that controls an image processing apparatus operable to create a pseudo three-dimensional image that improves depth perception of the image so as to execute a process including the steps of:
acquiring an input image and a binary mask image that specifies an object area on the input image;
extracting pixels in an area inside a quadrangular frame picture of the input image and pixels in the object area, specified by the binary mask image, on the input image to create a combined image; and
determining a position on the combined image at which the quadrangular frame picture is placed so that one of a pair of opposite edges of the quadrangular frame picture includes an intersection with a boundary of the object area and another of the pair does not include an intersection with the boundary of the object area.

10. An image processing apparatus creating a pseudo three-dimensional image that improves depth perception of the image, the apparatus comprising:
an input image acquiring unit acquiring an input image and a binary mask image that specifies an object area on the input image;
a combining unit extracting pixels in an area inside a quadrangular frame picture of the input image and pixels in the object area, specified by the binary mask image, on the input image to create a combined image; and
a frame picture combining position determining unit determining a position on the combined image at which the quadrangular frame picture is placed so that one of a pair of opposite edges of the quadrangular frame picture includes an intersection with a boundary of the object area and another of the pair does not include an intersection with the boundary of the object area.
